(19) United States
(12) Patent Application Publication
(10) Pub. No.: US 2024/0345028 A1
(43) Pub. Date: Oct. 17, 2024

(54) Eddy Current Testing System for Non-destructive Testing of Pipeline

(71) Applicant: SICHUAN DEYUAN PIPELINE TECHNOLOGY COMPANY LIMITED., Chengdu (CN)

(72) Inventors: Bin GAO, Chengdu (CN); Yupei YANG, Chengdu (CN); Yong ZHANG, Chengdu (CN); Liang SHEN, Chengdu (CN); Shiqiang JIANG, Chengdu (CN)

(21) Appl. No.: 18/748,337

(22) Filed: Jun. 20, 2024

Related U.S. Application Data
(63) Continuation of application No. 17/527,116, filed on Nov. 15, 2021.

(51) Int. Cl. G01N 27/90

(52) U.S. Cl. CPC G01N 27/9006

(57) ABSTRACT

The invention discloses an eddy current testing system for nondestructive testing of a pipeline, which belongs to the field of nondestructive testing technology. The eddy current testing system includes a data processing unit, a first signal conditioning unit, a second signal conditioning unit, and a testing probe, wherein the testing probe comprises an excitation coil, a receiving coil, and a passive resonance coil; and the passive resonance coil is arranged between the excitation coil and the receiving coil. According to the invention, no more magnetizing treatment device is needed for testing, so that the system volume is greatly reduced, thereby reducing the requirement of the testing system of the invention on cleanliness inside the pipeline, improving flexibility of equipment in the pipeline of the testing system, and greatly reducing the system cost; and by introducing the passive resonance coil between the excitation coil and the receiving coil, the coupling between the excitation coil and the receiving coil can be enhanced, thereby significantly improving the energy transmission efficiency, further improving the sensitivity of the testing probe so that the probe can accurately test pipeline defects at a higher lift-off height, and improving the defect detection capability of the probe.

### CROSS REFERENCE TO RELATED APPLICATION

This application is a continuation of U.S. patent application Ser. No. 17/527,116, filed on Nov. 15, 2021, and the entire contents of which are incorporated herein by reference.

### TECHNICAL FIELD

The invention relates to the field of nondestructive testing technology, in particular to an eddy current testing system for nondestructive testing of a pipeline.

### BACKGROUND

Pipeline transportation is regarded as one of the safest and most economical modes of transportation. During the operation of a pipeline, defects often appear in a pipeline body as time goes by. In the past decades, accidents caused by pipeline defects around the world have led to a large number of casualties and economic losses. To detect pipeline defects in advance and eliminate potential safety hazards, pipeline companies all over the world carry out periodic testing on pipelines to detect and repair pipeline defects in time, thus ensuring the safe and reliable operation of the pipelines.

Currently, methods such as magnetic flux leakage testing and ultrasonic testing are widely used to detect pipeline defects, which have become an important pre-control means to ensure the safe transportation of oil and gas pipelines and are of great significance in eliminating risk factors of the pipelines. With better qualitative and quantitative analysis capability of the defects, the above testing method can effectively evaluate the operating state of the pipeline, and indirectly reduce the incidence of pipeline accidents, thus avoiding heavy losses to the national economy and heavy casualties. However, a magnetic flux leakage testing instrument is heavy and has certain requirements on flow, flow rate, and pressure of medium. Multiple pigging is required before testing, which has high requirements on the cleanliness of an inner pipe wall. A small-diameter magnetic flux leakage pipeline detector is long, and its flexibility is easily affected. The couplant is required for ultrasonic testing, featuring a low testing speed and therefore a long time for testing, and having a certain near-field blind area, thus easily causing missed detection. To overcome the problems of large equipment size, poor flexibility of equipment in the pipeline, high requirements on the cleanliness inside the pipeline, and low testing efficiency in the aforesaid testing methods, an eddy current testing system applicable to the conductive pipeline testing is put forward.

Eddy current testing is now an effective method for quantitative nondestructive evaluation of surface/sub-surface defects of pipeline structures. It features a rapid non-contact testing process with a higher capability to test surface/sub-surface shallow defects, has become an important pre-control means to ensure the safe transportation of oil and gas pipelines, and is of great significance in eliminating risk factors of the pipelines.

A testing probe of the existing eddy current testing system generally includes an excitation coil and an induction coil (testing coil). An eddy current field is formed via induction on the surface of a tested piece (tested specimen) under the effect of a varying magnetic field generated by the excitation coil. The size and shape of the eddy current field depend on the degree of excitation, coil parameters, materials of the tested specimen, etc. When the testing probe detects the defect, the original eddy current goes around the defect, which disturbs the eddy current and further affects the magnetic field generated by the eddy current. The defects can be qualitatively and quantitatively analyzed by detecting the change in the magnetic field with the testing coil or a magnetic sensor and extracting the phase and amplitude of a testing signal. The sensitivity and the lift-off height of the eddy current testing probe have always been a hotspot in the eddy current testing field, and the coupling degree between the excitation coil and the testing coil is an important factor affecting the sensitivity and the lift-off height of the testing probe. Therefore, an urgent technical problem to be solved at present is how to improve the coupling degree between the excitation coil and the testing coil.

### SUMMARY OF THE INVENTION

The invention aims to overcome the problem of low sensitivity and small lift-off height of the testing probe due to the low coupling degree between the excitation coil and the receiving coil of the existing eddy current testing probe and provides an eddy current testing system for nondestructive testing of a pipeline.

The purpose of the invention is achieved by the following technical solutions: an eddy current testing system for nondestructive testing of a pipeline, specifically comprising a data processing unit, a first signal conditioning unit, a second signal conditioning unit, and a testing probe, wherein the testing probe comprises an excitation coil, a receiving coil, and a passive resonance coil; the passive resonance coil is arranged between the excitation coil and the receiving coil; the data processing unit is used to generate an excitation signal; the data processing unit, the first signal conditioning unit and the excitation coil are connected in sequence; and the receiving coil, the second signal conditioning unit, and the data processing unit are connected in sequence.

In an example, the first signal conditioning unit comprises a digital-to-analog conversion module and a first signal amplification module which are connected in sequence; and the second signal conditioning unit comprises a second signal amplification module and an analog-to-digital conversion module which are connected in sequence.

In an example, the system further comprises a mileage testing unit, and an output end of the mileage testing unit is connected with the data processing unit.

In an example, the system further comprises a management control unit and/or a host computer in a two-way connection with the data processing unit.

In an example, geometric centers of the excitation coil, the passive resonance coil, and the receiving coil are collinear.

In an example, the excitation coil is a differential coil, and the passive resonance coil and the receiving coil are absolute coils.

For example, the excitation coil, the passive resonance coil, and the receiving coil are PCB planar coils or FPC planar coils.

In an example, the excitation coil comprises two rectangular field coils which are symmetrically arranged.

In an example, the passive resonance coil comprises a plurality of PCB resonance sub-coils which are connected in series and arranged in layers; and the receiving coil comprises a plurality of PCB receiving sub-coils which are connected in series and arranged in layers.

In an example, the passive resonance coil is connected with a resonance point regulating capacitor in series.

It should be further noted that the technical features corresponding to the above-mentioned examples may be combined or replaced with each other to form a new technical solution.

Compared with the prior art, the invention has the following beneficial effects:

(1) In an example, the eddy current testing system is composed of the data processing unit, the first signal conditioning unit, the second signal conditioning unit, and the testing probe, without additional magnetizing treatment devices, so that the system volume is greatly reduced, thereby reducing the requirement of the testing system of the invention on cleanliness inside a pipeline, improving flexibility of equipment in the pipeline of the testing system, and greatly reducing the system cost; and further, by introducing the passive resonance coil between the excitation coil and the receiving coil, the coupling between the excitation coil and the receiving coil can be enhanced, thereby significantly improving the energy transmission efficiency, further improving the sensitivity of the testing probe so that the probe can accurately test pipeline defects at a higher lift-off height, and improving the defect detection capability of the probe.

(2) In an example, the system of the invention further comprises a mileage testing unit, which is used to acquire mileage information of a mobile carrier carried by the testing system, to accurately locate the pipeline defects.

(3) In an example, the system of the invention further comprises the host computer, which is used to analyze the testing information fed back by the testing probe, to determine the presence of defects of the pipeline and locate the position of the defective pipeline. In addition, the host computer can also transmit the analysis results of these data to a server to realize data storage and sharing, and thus realize defect information traceability management of different pipelines.

(4) In an example, the energy transmission efficiency can be maximized by aligning the geometric centers of the excitation coil, the passive resonance coil, and the receiving coil.

(5) In an example, the excitation coil is a differential coil, and the differential coil can form a uniform eddy current in the central area of the coil, and when defects are detected, the eddy current is changed in the middle eddy current area, thus changing the magnetic field and facilitating the identification of defective parts.

(6) In an example, the probe adopts the PCB planar coil, and features a small size and high sensitivity to surface defects. In addition, with small effective lift-off height, the probe is highly sensitive to defects and has a broad application prospect in the field of eddy current testing. Further, the PCB planar coil can be directly manufactured and permanently fixed on the moving component. Furthermore, the PCB planar coil is flexible enough to allow consistency of the coil with the pipeline surface to be tested, so the testing probe also has a very broad application prospect in testing complex surface geometry.

(7) In an example, under the action of the resonance coil, the receiving sub-coils arranged in a multi-layered structure can improve the testing sensitivity while reducing the optimal testing frequency, and effectively reducing the requirements for excitation signals. Meanwhile, a multi-coil array created by a plurality of resonance sub-coils and receiving sub-coils can increase the testing range and reduce the testing time.

(8) In an example, by adjusting the capacitance of the resonance point regulating capacitor to adjust the resonance point of the coil, the testing capability of the testing probe can be improved to be suitable for a wider testing environment.

### DESCRIPTION OF THE DRAWINGS

A further detailed description is made below to the specific embodiments in combination with drawings. The drawings described herein are used to help further understand the invention and constitute a part of the invention. In the drawings, the same reference marks indicate the same or similar parts. The illustrative embodiments and corresponding descriptions do not constitute improper limitations but for explaining the invention.

FIG. 1 is a schematic diagram of a testing system in an example of the invention;

FIG. 2 is a diagram of an excitation coil in an example of the invention;

FIG. 3 is a diagram of a resonance coil in an example of the invention;

FIG. 4 is a diagram of a receiving coil in an example of the invention;

FIG. 5 is a schematic diagram showing the comparison of the testing effects before and after providing the resonance coil in an example of the invention;

FIG. 6 is a testing diagram of a tested ferromagnetic flat specimen with different sizes and different types of artificial defects in an example of the invention;

FIG. 7 is a diagram showing testing results of defects with different inclination angles under the condition of 5 mm lift-off in an example of the invention;

FIG. 8 is a diagram showing overall testing of X80 pipeline defects in an example of the invention;

FIG. 9 is a testing diagram of a single sensor for X80 pipeline defects in an example of the invention;

FIG. 10 is a testing diagram of the odometer wheel in an example of the invention;

FIG. 11 is a schematic diagram showing acceleration testing results of a pipeline cleaner in an example of the invention;

FIG. 12 is a schematic diagram showing Euler angle testing results of the pipeline cleaner in an example of the invention.

### EMBODIMENTS

The following is a clear and complete description of the technical solution of the invention in combination with the drawings. Obviously, the embodiments are only some of rather than all of the embodiments of the invention. All other embodiments obtained by persons of ordinary skill in the art based on the embodiments of the invention without creative efforts shall fall within the protection scope of the invention.

It should be noted that the directions or position relationships such as “central”, “upper”, “lower”, “left”, “right”, “vertical”, “horizontal”, “inside”, and “outside” in the description of the invention are based on those on drawings, and are used only for facilitating the description of the invention and for simplified description, not for indicating or implying that the target devices or components must have a special direction and be structured and operated at the special direction, therefore, they cannot be understood as the restrictions to the disclosure. Moreover, the words “first” and “second” are used only for description, and cannot be understood as an indication or implication of relative importance.

It should be noted in the description of the invention that unless otherwise specified or restricted, the words “installation”, “interconnection” and “connection” shall be understood as a general sense. For example, the connection can be fixed connection, removable connection, integrated connection, mechanical connection, electrical connection, direct connection, indirect connection through intermediate media, or connection between two components. Persons of ordinary skill in the art can understand the specific meanings of the above terms in the invention as the case may be.

Moreover, the technical characteristics involved in different embodiments of the invention as described below can be combined provided that no discrepancy is provided among them.

### Embodiment 1

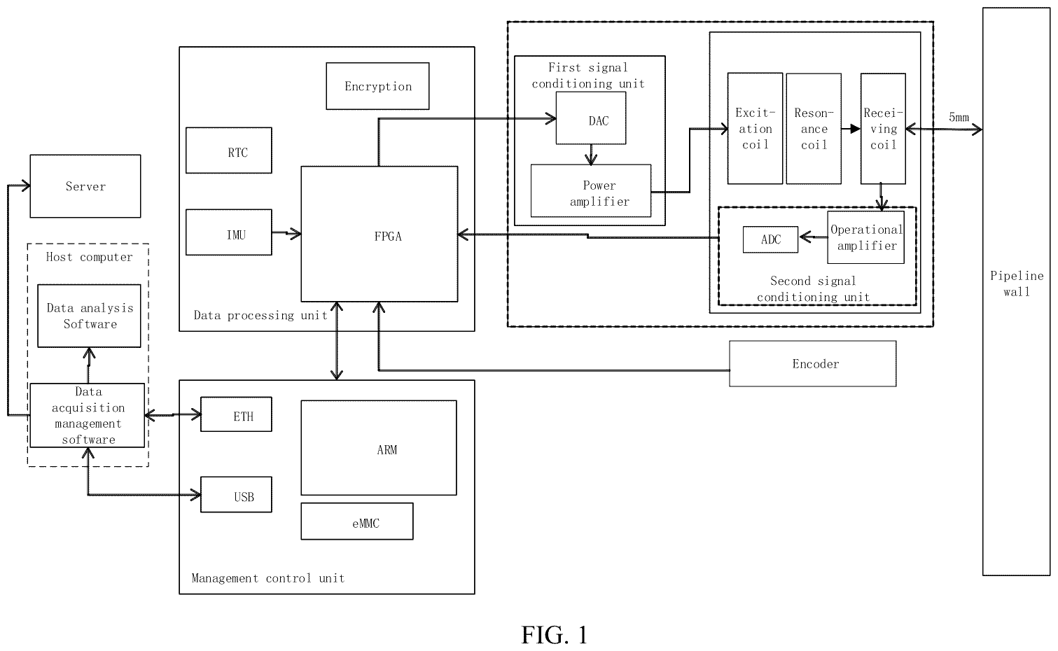

As shown in FIG. 1, in Embodiment 1, an eddy current testing system for nondestructive testing of a pipeline comprises a data processing unit, a first signal conditioning unit, a second signal conditioning unit, and a testing probe, wherein the testing probe comprises an excitation coil and a receiving coil which are mutually induced, and also comprises a passive resonance coil arranged between the excitation coil and the receiving coil; the data processing unit, the first signal conditioning unit, and the excitation coil are connected in sequence; and the receiving coil, the second signal conditioning unit, and the data processing unit are connected in sequence. Wherein the data processing unit is used for generating an excitation signal to the first signal conditioning unit and receiving testing information fed back by the second signal conditioning unit, and also used for MPU calibration, RTC timing, etc. As an option, the data processing unit in this example is specifically an FPGA, featuring strong data processing capability and low cost. In this example, the eddy current testing system is composed of the data processing unit, the first signal conditioning unit, the second signal conditioning unit, and the testing probe, without additional magnetizing treatment devices, so that the system volume is greatly reduced, thereby reducing the requirement of the testing system of the invention on cleanliness inside a pipeline, improving flexibility of equipment in the pipeline of the testing system, and greatly reducing the system cost; and further, the excitation coil generates a primary magnetic field under the action of the excitation signal and is mutually induced with the receiving coil so that the energy of the excitation coil is wirelessly transmitted to the receiving coil. By introducing the passive resonance coil between the excitation coil and the receiving coil, the coupling between the excitation coil and the receiving coil can be enhanced, thereby significantly improving the energy transmission efficiency, further improving the sensitivity of the testing probe so that the probe can accurately test pipeline defects at a higher lift-off height, and improving the defect detection capability of the probe.

In an example, the first signal conditioning unit comprises a digital-to-analog conversion module and a first signal amplification module which are connected in sequence; and the second signal conditioning unit comprises a second signal amplification module and an analog-to-digital conversion module which are connected in sequence. More specifically, the digital-to-analog conversion module is an ADC chip; the first signal amplification module is specifically a power amplifier, and the second signal conditioning unit comprises a power supply voltage stabilizing chip for providing 5V operating voltage and a power supply voltage stabilizing chip for providing 3.3V operating voltage and further comprises an operational amplifier for amplifying signals and a standard voltage chip for providing 4.096V voltage. The 4.096V voltage is divided into 2.048V voltage, which is supplied to the operational amplifier and then output to the ADC chip (analog-to-digital conversion module) after differential amplification. The ADC acquisition chip is a 16-bit, IMSPS digital-to-analog converter with true differential input, and provides an SPI interface to output the acquired testing data to the data processing unit. The second signal conditioning unit further comprises a 4-bit dual power transceiver and supports bidirectional level conversion. The signal converted by the ADC and the clock provided by the data processing unit allows a circuit to have a stronger anti-interference through the chip. As an option, the signal conditioning unit further comprises a filtering module, which is connected with the signal amplification module and used for filtering a clutter signal.

In an example, the system further comprises a mileage testing unit, and an output end of the mileage testing unit is connected with the data processing unit. Specifically, the mileage testing unit is an encoder. When the testing system of the invention is mounted on a mobile carrier to test pipeline defects, the encoder is used for collecting mileage information of the mobile carrier and feeding the same back to the data processing unit.

In an example, the testing system further comprises a management control unit and a host computer which are in a two-way connection with the data processing unit, the management control unit is connected with the host computer at the same time, and the host computer is connected with the server. Specifically, the management control unit is used for self-testing of the testing probe, IMU self-testing, configuration management, data file management, etc., wherein the self-testing of the sensor refers to performing start-stop control and real-time data viewing; configuration management is used to test parameter configuration, RTC timing and parameter configuration for local storage of equipment; and data file management is mainly used for data file reading and conversion. Further, the host computer is equipped with data acquisition management software, the data processing unit transmits the testing information (data) fed back by the second signal conditioning unit to the management control unit for storage, and the management control unit further transmits the feedback information to the host computer via the data management software, or the management control unit transmits the feedback information to the data management software of the host computer via the wireless communication module. The testing information is analyzed through the data management software integrated into the host computer, to judge whether the defects occur in the pipelines and to locate the defective pipelines. The host computer transmits the data analysis results to a server at the same time, thus realizing data storage and sharing.

In an example, the geometric centers of the excitation coil, the passive resonance coil, and the receiving coil are collinear, i.e., the excitation coil, the passive resonance coil, and the receiving coil are arranged coaxially, thus improving the energy transmission efficiency to the maximum extent.

In an example, the excitation coil, the passive resonance coil, and the receiving coil are rectangular coils spirally wound with copper wires, in which the defects with different shapes are distinguished from others in the circular structure more easily.

In an example, the excitation coil is a differential coil, and the differential coil can form a uniform eddy current in the central area of the coil, and when defects are detected, the eddy current is changed in the middle eddy current area, thus changing the magnetic field and facilitating the identification of defective parts.

In an example, the excitation coil, the passive resonance coil, and the receiving coil are PCB planar coils, featuring small size and high sensitivity to surface defects. In addition, with small effective lift-off, the PCB planar coil is highly sensitive to defects and has a broad application prospect in the field of eddy current testing. Further, the PCB planar coil can be directly manufactured and permanently fixed on the moving component. Furthermore, the PCB planar coil is flexible enough to allow consistency of the coil with the pipeline surface to be tested, so the testing probe also has a very broad application prospect in testing complex surface geometry.

In an example, the excitation coil comprises two rectangular field coils which are symmetrically arranged to generate more uniform eddy currents under the action of the excitation signal.

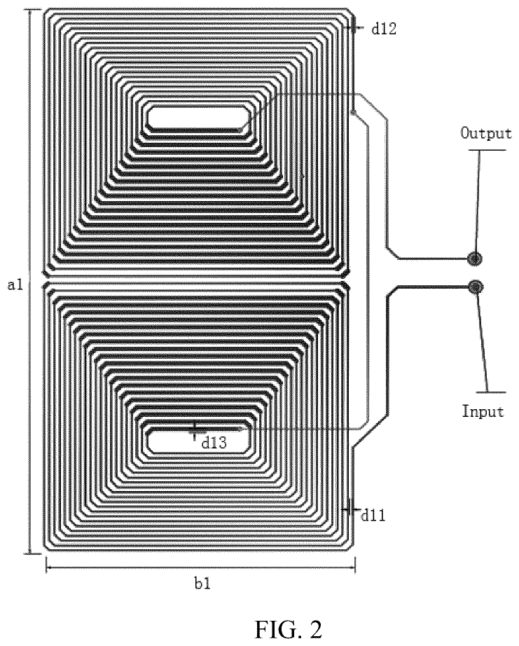

As a preferred embodiment, as shown in FIG. 2, the excitation coil of the utility model is a single-layer PCB rectangular differential coil, with a length of a1 and a width of b1, a wire diameter of a middle differential area of d11, a wire diameter of other wires of d12, a wire spacing of d13, and d11>d12. In the Embodiment, the wire diameter d11 of the differential area ranges from 0.500 mm to 0.510 mm, the rest wire diameters range from 0.250 mm to 0.260 mm, the wire spacing ranges from 0.250 mm to 0.260 mm, and the whole excitation coil ranges from 56.630 mm to 56.640 mm in terms of length and ranges from 30.520 mm to 30.530 mm in terms of width. More specifically, the excitation coil is provided with an input interface input1 and an output interface output1 for an external excitation signal.

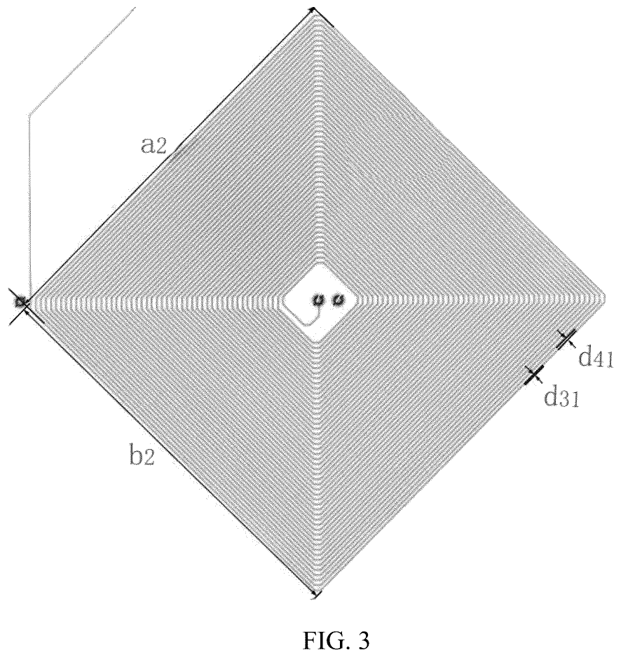

In an example, the passive resonance coil comprises a plurality of PCB resonance sub-coils which are connected in series and arranged in layers. As a preferred embodiment, the testing probe comprises four layers of passive resonance sub-coils. As shown in FIG. 3, the resonance sub-coil has a length of a2, a width of b2, a copper wire diameter of d31, and a wire spacing of d41. More specifically, via holes are formed between the resonance sub-coils in different layers, and the resonance sub-coils in different layers are connected in series through the copper wires. In the Embodiment, the PCB rectangular resonance sub-coil of each layer has a wire diameter ranging from 0.0880 mm to 0.0890 mm, a wire spacing ranging from 0.0880 mm to 0.0890 mm, a length ranging from 29.440 mm to 29.450 mm, and a width ranging from 29.440 mm to 29.450 mm.

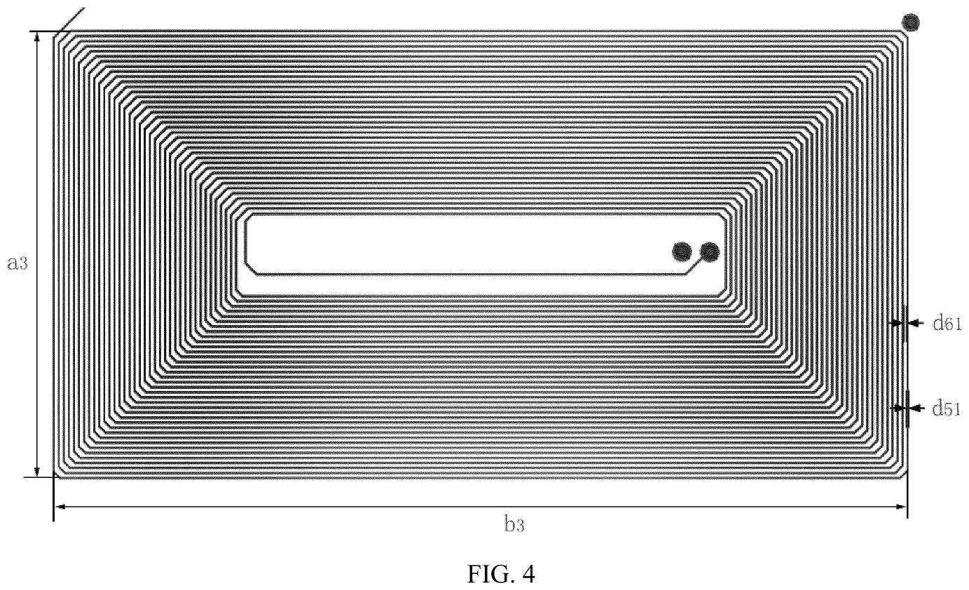

In an example, the receiving coil comprises a plurality of PCB receiving sub-coils connected in series and arranged in layers. As a preferred embodiment, the testing probe comprises four layers of receiving sub-coils. As shown in FIG. 4, the receiving sub-coil has a length of a3, a width of b3, a copper wire diameter of d51, and a wire spacing of d61. Via holes are formed between the receiving sub-coils in different layers, and the receiving sub-coils in different layers are connected in series through the copper wires. In the Embodiment, the PCB rectangular receiving sub-coil of each layer has a wire diameter ranging from 0.0880 mm to 0.0890 mm, a wire spacing ranging from 0.0880 mm to 0.0890 mm, a length ranging from 10.430 mm to 10.440 mm, and a width ranging from 24.750 mm to 24.760 mm. More specifically, the input interface input2 is arranged on the first layer, and the output interface output2 is arranged on the fourth layer. The back-end data processing unit is connected through two interfaces.

As a preferred embodiment, the testing probe of the invention comprises an excitation coil, four layers of resonance sub-coils, and four layers of receiving sub-coils. The whole probe is small in size and convenient to install. For the invention, under the action of the resonance coil, the receiving coil arranged in a multilayered structure can improve the inductance value of the coil, etc., and further can better induce the change in the magnetic flux of the pipeline to be tested, thus improving the testing sensitivity, reducing the optimal testing frequency, and effectively reducing the requirements on excitation signal. Further, a multi-coil array created by a plurality of resonance sub-coils and receiving sub-coils can increase the testing range and reduce the testing time.

In an example, the passive resonance coil is connected with a capacitor in series, as shown in FIG. 3, which is connected with the capacitor via a wire on the left side of the coil. When the passive resonance coil comprises a plurality of resonance sub-coils, one resonance sub-coil is connected in series with a resonance point regulating capacitor, and two via holes are formed outside the resonance sub-coil to place the capacitor. The resonance point of the coil can be adjusted by the capacitance of the capacitor, thereby improving the testing capability of the testing probe to be suitable for a wider testing environment.

For example, bending positions of the excitation coil, the passive resonance coil, and the receiving coil are all chamfered at 45° to reduce electromagnetic interference and signal emission and reducing the signal noise when the external signal frequency is high.

To further illustrate the inventive concept of the invention, the combination of the above examples is now taken as a preferred embodiment, and the working principle of the testing system of the preferred embodiment is described:

The testing system is arranged on the mobile carrier and placed in a conductive pipeline to be tested, and the testing system starts to work after being powered on. The data processing unit FPGA generates a sine wave excitation signal with a frequency of IM through a first digital-to-analog conversion module DAC by a DDS method, and the sine wave excitation signal is amplified to 6V by a power amplifier and applied to the excitation coil; the excitation coil is driven by the excitation signal to generate a primary magnetic field, and a passive resonance coil enhances the coupling between the excitation coil and the receiving coil and the tested pipeline. When the tested specimen (tested pipeline) is in the primary magnetic field, the primary magnetic field generates eddy current on the surface of the tested specimen, and the flow direction of the eddy current changes at the defect. A secondary magnetic field generated by the eddy current changes due to a change in the eddy current. Changes in the amplitude and phase of the receiving coil are detected by detecting a change in the magnetic flux of the receiving coil. Therefore, the induced voltage generated by the primary magnetic field and the induced voltage generated by the secondary magnetic field (feedback testing signal) are amplified by the operational amplifier, converted into digital signals recognizable by the data processing unit FPGA through the ADC, and then transmitted to the data processing unit. The data processing unit transmits the feedback testing signal to the host computer. The host computer extracts the amplitude and phase value of the testing signal, obtains the change in the amplitude and phase of the testing signal, and accurately detects the relevant defect information of the tested specimen and the positions of defective pipelines in combination with the coded signal fed back by the encoder.

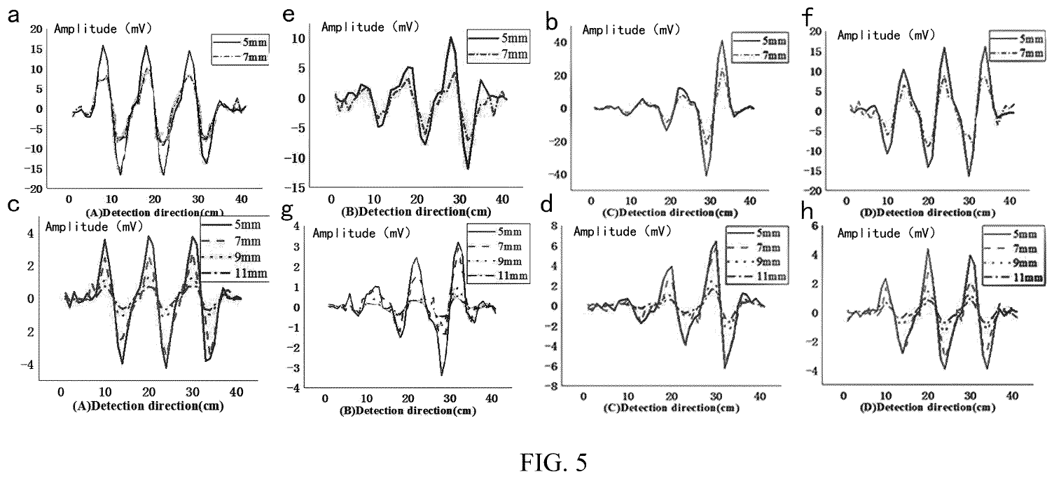

To further illustrate the technical effect of the application, a concrete testing effect diagram of the resonance coil introduced for the testing probe of the application is given. Wherein FIG. 5 is a diagram showing the comparison of the testing effects before and after a passive resonance coil is provided in the application, wherein FIGS. 5(a) and (c) are mutually referenced, FIGS. 5(e) and (g) are mutually referenced, FIGS. 5(b) and (d) are mutually referenced, FIGS. 5(f) and (h) are mutually referenced, FIGS. 5(a)-(d) are testing diagrams after the passive resonance coil is provided, and FIGS. 5(e)-(h) are testing diagrams after the passive resonance coil is not provided. In the Figures, the horizontal coordinates indicate the detection direction in cm, and the ordinates indicate the amplitude. It can be clearly seen from FIG. 5 that the amplitude of the acquired defect detection information changes within an mV range when the passive resonance coil is not provided, and the amplitude of the acquired defect detection information changes within a V level range when the passive resonance coil is provided under the same lift-off condition, that is, the amplitude of the testing probe with the passive resonance coil provided changes more than that without the passive resonance coil provided. Further, when the passive resonance coil is not provided, to ensure the testing sensitivity of the probe, the maximum lift-off value of the testing probe is 7 mm. After the passive resonance coil is provided, the testing probe still has high testing sensitivity (large amplitude change) when the lift-off value is 11 mm. Namely, the maximum lift-off value of the testing probe in the application can be greater than 11 mm, thus having more excellent testing performance.

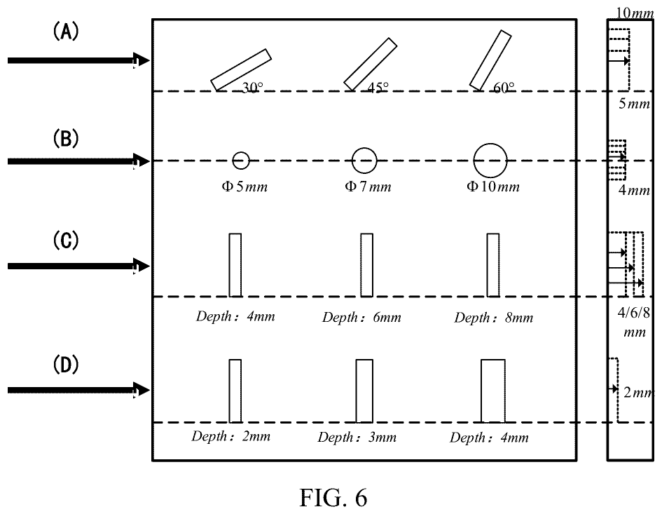

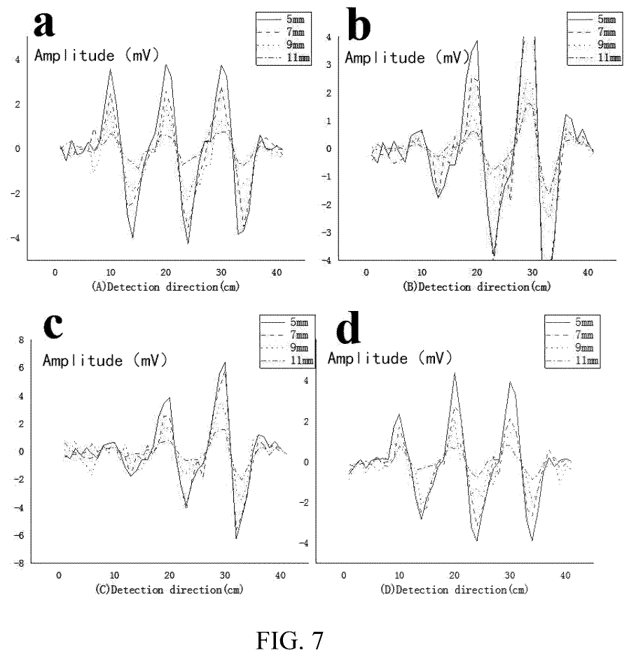

Further, the length, width, and thickness of the artificial defect sample in the application are 450 mm, 300 mm, and 10 mm respectively. FIG. 6 shows various surface defects except for circular defects in samples with a thickness of 10 mm, a length of 20 mm, and a width of 2 mm, and defects with a width of 3 mm and 4 mm as shown in FIG. 7, wherein the three defects have a depth of 5 mm and the inclination angles of 30°, 45°, and 60° respectively. Three different circular defects have a depth of 4 mm and a respective diameter of 5 mm, 7 mm, and 10 mm; three rectangular defects have different depths, which are 4 mm, 6 mm, and 8 mm respectively; and three rectangular defects with a depth of 2 mm have different widths of 2 mm, 3 mm and 4 mm, respectively.

FIGS. 7(a)-7(d) are diagrams showing the testing results of ferromagnetic plate defects with different types and sizes by using the testing probe of the invention under the condition of 5 mm lift-off and a moving speed of 10 mm/s, wherein FIG. 7(a) is a diagram showing testing results of defects with different inclination angles under the condition of 5 mm lift-off; FIG. 7(b) is a diagram showing the testing results of circular defects with different sizes under the condition of 5 mm lift-off; FIG. 7(c) is a diagram showing the testing results of defects with different sizes and depths under the condition of 5 mm lift-off; FIG. 7(d) is a diagram showing the testing results of defects with different scales and widths under the condition of 5 mm lift-off. In FIG. 7, the horizontal coordinates indicate the detection direction in cm, and the vertical coordinates indicate the amplitude in V. When the testing probe passes through the defect-free position, the testing signal amplitude keeps unchanged; and when the testing probe passes through the defect position, the testing signal amplitude changes and the changed amplitude and time are related to the size of the defect. In this experiment, when the area of the defect becomes larger or the depth becomes deeper, the signal change amplitude becomes larger and the signal change time is longer.

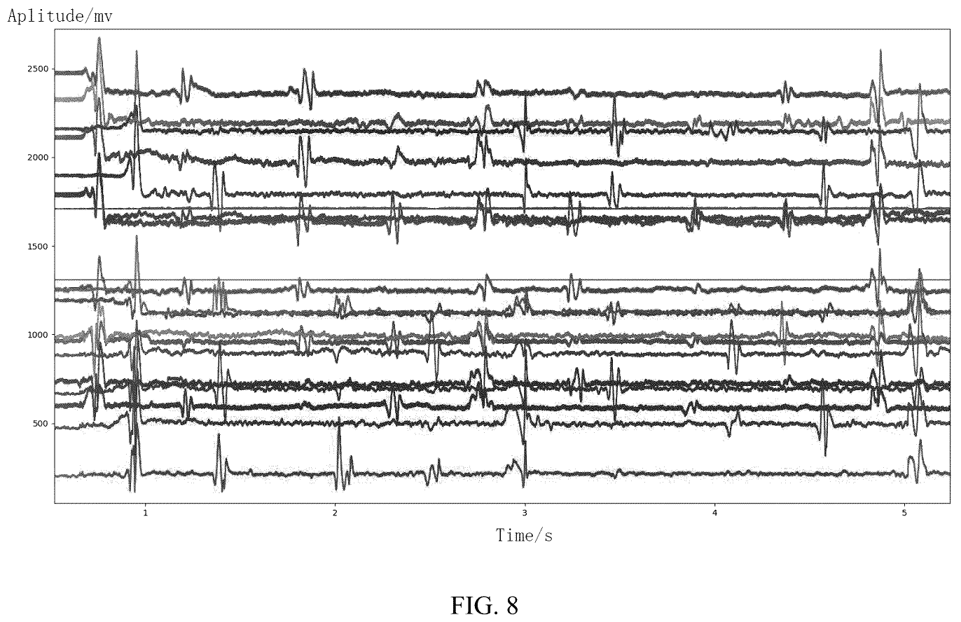

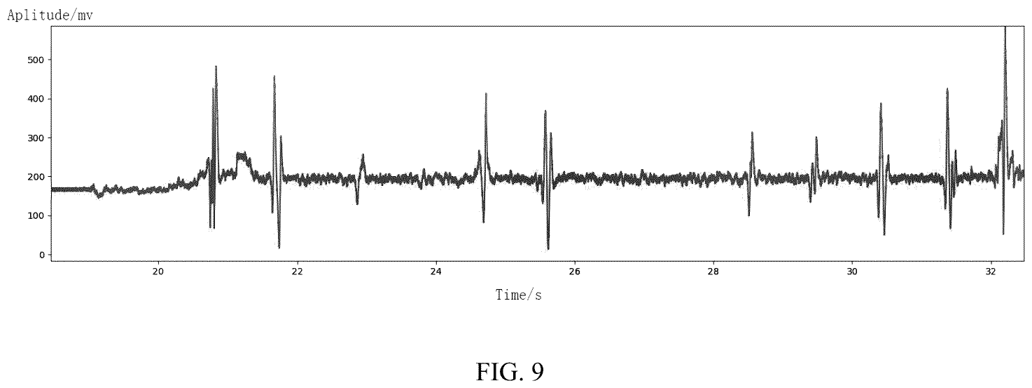

FIG. 8 shows an overall testing result of X80 pipeline defects by using the sensor of the invention, wherein the horizontal coordinate indicates the time(s) for the testing probe to move at 0.5 m/s, and the vertical coordinate indicates the amplitude (mv) of defects. FIG. 9 shows a single sensor testing result of X80 pipeline defects by using the sensor of the invention, wherein the horizontal coordinate indicates the time(s) for the testing probe to move at 0.5 m/s, and the vertical coordinate indicates the testing amplitude (mv). It can be seen from the amplitude change in the Figure that the sensor of the invention has a good testing result for pipeline defects.

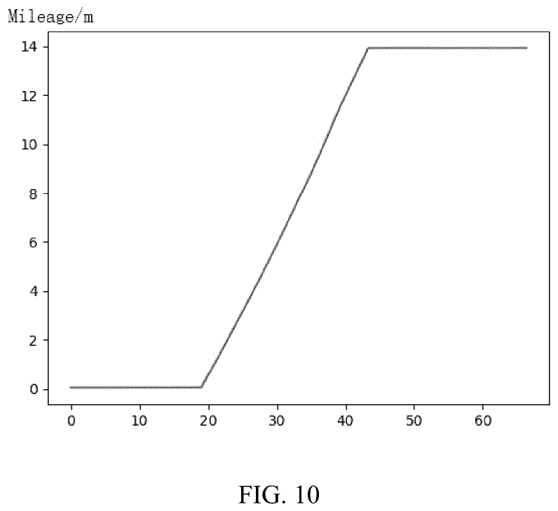

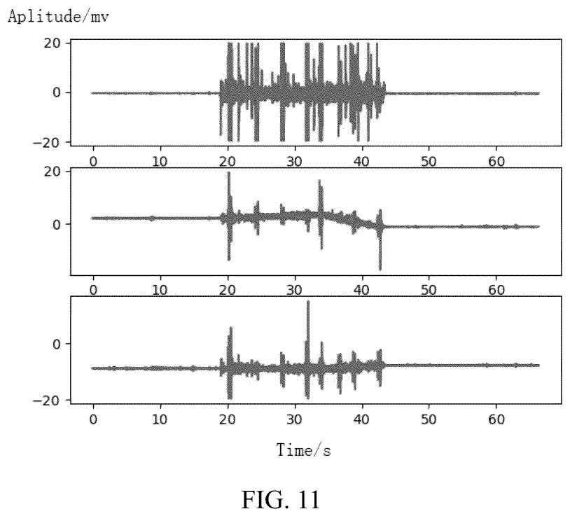

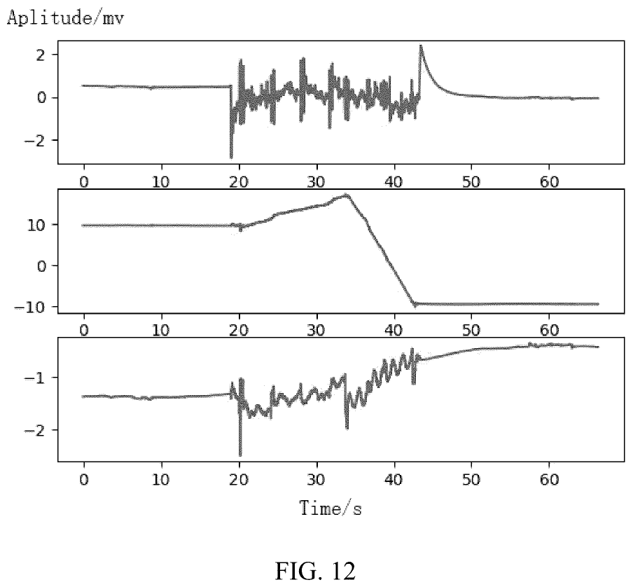

FIGS. 10-12 are schematic diagrams showing encoder information collection by using the sensor of the invention, which is used to identify a moving distance and posture of the inner sensor, wherein FIG. 10 is a testing diagram of an odometer wheel; FIG. 11 is a schematic diagram showing acceleration testing results of a pipeline cleaner, and FIG. 12 is a schematic diagram showing Euler angle testing results of the pipeline cleaner. In FIGS. 10-12, the horizontal coordinates indicate the time(s) for the testing probe to move at 0.5 m/s, and the vertical coordinates indicate the testing amplitude (mv).

The above specific embodiments are detailed descriptions of the invention, and it could not be considered that the specific embodiments of the invention are only limited to these descriptions. Persons of ordinary skill in the art could also make some simple deductions and substitutions without departing from the concept of the invention, which should be deemed to fall within the protection scope of the invention.

1. An eddy current testing system for nondestructive testing of a pipeline, comprising a data processing unit, a first signal conditioning unit, a second signal conditioning unit, and a testing probe, wherein the testing probe comprises an excitation coil, a receiving coil, and a passive resonance coil; and the passive resonance coil is arranged between the excitation coil and the receiving coil;
the data processing unit is used to generate an excitation signal; the data processing unit, the first signal conditioning unit and the excitation coil are connected in sequence; and the receiving coil, the second signal conditioning unit, and the data processing unit are connected in sequence.

2. The eddy current testing system for nondestructive testing of the pipeline according to claim 1, wherein the first signal conditioning unit comprises a digital-to-analog conversion module and a first signal amplification module which are connected in sequence; and the second signal conditioning unit comprises a second signal amplification module and an analog-to-digital conversion module which are connected in sequence.

3. The eddy current testing system for nondestructive testing of the pipeline according to claim 1, wherein the system further comprises a mileage testing unit, and an output end of the mileage testing unit is connected with the data processing unit.

4. The eddy current testing system for nondestructive testing of the pipeline according to claim 1, wherein the system further comprises a management control unit and/or a host computer which are bidirectionally connected with the data processing unit.

5. The eddy current testing system for nondestructive testing of the pipeline according to claim 1, wherein geometric centers of the excitation coil, the passive resonance coil, and the receiving coil are collinear.

6. The eddy current testing system for nondestructive testing of the pipeline according to claim 1, wherein the excitation coil is a differential coil.

7. The eddy current testing system for nondestructive testing of the pipeline according to claim 1, wherein the excitation coil, the passive resonance coil, and the receiving coil are PCB planar coils.

8. The eddy current testing system for nondestructive testing of the pipeline according to claim 1, wherein the excitation coil comprises two rectangular field coils which are symmetrically arranged.

9. The eddy current testing system for nondestructive testing of the pipeline according to claim 1, wherein the passive resonance coil comprises a plurality of PCB resonance sub-coils which are connected in series and arranged in layers, and the receiving coil comprises a plurality of PCB receiving sub-coils which are connected in series and arranged in layers.

10. The eddy current testing system for nondestructive testing of the pipeline according to claim 1, wherein the passive resonance coil is connected with a resonance point regulating capacitor in series.
